(19) United States
(12) Patent Application Publication
(10) Pub. No.: US 2018/0006745 A1
(43) Pub. Date: Jan. 4, 2018

(54) COMPACT SYSTEM FOR CHARACTERIZING A DEVICE UNDER TEST (DUT) HAVING INTEGRATED ANTENNA ARRAY

(71) Applicant: Keysight Technologies, Inc., Minneapolis, MN (US)

(72) Inventor: Gregory Douglas Vanwiggeren, San Jose, CA (US)

(21) Appl. No.: 15/583,104

(22) Filed: May 1, 2017

Related U.S. Application Data
(60) Provisional application No. 62/357,120, filed on Jun. 30, 2016.
(60) Provisional application No. 62/380,984, filed on Aug. 29, 2016.

(51) Int. Cl. H04B 17/391; H04B 10/073; H04W 24/08

(52) U.S. Cl. CPC H04B 17/3912; H04B 10/0731; H04W 24/08; H04B 2210/006

(57) ABSTRACT

A system is provided for characterizing a device under test (DUT) including an integrated antenna array. The system includes an optical subsystem having first and second focal planes, where the integrated antenna array is positioned substantially on the first focal plane of the optical subsystem. The system further includes a measurement array having one or more array elements positioned substantially on the second focal plane of the optical subsystem, the measurement array being configured to receive signals transmitted from the integrated antenna array via the optical subsystem. A far-field radiation pattern of the integrated antenna array is created at the measurement array, enabling measurements of DUT parameters at each array element of the one or more array elements in the measurement array.

### PRIORITY

The present application claims priority under 35 U.S.C. §119(e) from commonly owned U.S. Provisional Application No. 62/357,120, filed on Jun. 30, 2016, to Gregory Vanwiggeren, and from commonly owned U.S. Provisional Application No. 62/380,984, filed on Aug. 29, 2016, to Gregory Vanwiggeren. The entire disclosures of U.S. Provisional Application Nos. 62/357,120 and 62/380,984 are specifically incorporated herein by reference.

### BACKGROUND

Antenna arrays are increasingly used in electronic communications, including in the aerospace defense industry and the wireless telecommunications industry, for example. Antenna array test and calibration solutions are used to characterize the antenna arrays. Conventional solutions for test and calibration depend primarily on a vector network analyzer, which requires the device under test (DUT) including the antenna array, or antenna under test (AUT), to have radio frequency (RF) connectors, such as coaxial connectors, in order to perform the test and calibration. However, with the evolution of wireless communication technologies, antenna arrays with direct connections to (i.e., integrated with) RF transceivers of DUTs, and having no RF connectors, are becoming increasingly common. Overall performance of such a DUT presently must be tested “over-the-air,” since there is no place to connect a coaxial cable from the DUT and/or the antenna array to the test equipment. In fact, due to antenna array integration, overall DUT performance must now be tested as a function of the antenna array configuration. When the antenna array is designed to produce signal beams, for instance, then the DUT performance must be characterized over a range of beam angles and/or widths.

Conventional solutions for over-the-air testing are aimed primarily at single antenna measurements. However, with the advent of mmW wireless communication standards, such as IEEE 802.11ad, and the advent of 5G networks, cost, size and speed become key attributes of test methodology. To characterize performance, various attributes of the DUT, such as radiation profile, effective isotropic radiated power, total radiated power, error-vector-magnitude (EVM) of the modulation, and adjacent channel leakage ratios (ACLRs), for example, must all be characterized as a function of beam angle. Currently, this involves a very time-consuming process. For example, characterizing just the radiation profiles of a DUT as a function of beam angle may take hours.

Antenna characterization processes typically take place either at an outdoor test range or in an anechoic chamber test range. The outdoor test ranges are used for antennas having a very long far-field (e.g., greater than 5 m), rendering use of an indoor test range or anechoic chamber impractical. Anechoic test ranges are shielded chambers with walls covered in absorbing material that minimizes internal reflections, typically by several tens of decibels.

There are a number of basic conventional techniques for antenna characterization using an anechoic chamber. First, for example, there is a simple-far-field measurement technique, which is appropriate when the antenna's far-field occurs at a sufficiently short distance that it can be measured in a chamber of practical size, e.g., less than a couple meters on the longest side. Second, there is the near-field measurement technique, according to which near-field measurements are mathematically transformed to the far-field. This type of measurement involves a raster scan over a plane in front of an antenna, or a cylinder or spherical surface around an antenna, and then a Fourier transform of corresponding measurements to calculate the far-field pattern of the antenna. Third, there is a compact anechoic test range (CATR) technique, according to which an approximately uniform source (a single antenna) illuminates a curved mirror where the resulting reflection is nearly perfectly collimated. In this way, the antenna of the DUT with a long far-field distance can be positioned in the collimated beam, and its radiation pattern determined as the received power changes as a function of rotation angle (elevation and azimuth) of the DUT. The collimated reflection from the curved mirror allows the DUT to be characterized in the far-field in a more compact chamber than would otherwise be possible without the curved mirror.

However, for the types of antenna arrays that will be developed for 5G backhaul or last mile applications, there may be many antenna elements, and the far-field is prohibitively large for the simple far-field measurements to be performed in an anechoic chamber. For manufacturing testing, an outdoor test range is also precluded. Only the second and third techniques, for example, may be considered for these sorts of long far-field devices.

Also, for the new generation of integrated antenna arrays, the antenna array cannot be tested in isolation. In other words, it is not sufficient, or even possible since the antenna array is directly integrated with the transceiver, to simply test the antenna radiation profile, and then separately test the functionality of the transmitter and/or receiver chain of the DUT with which the antenna array is integrated. Rather, the transmitter and/or receiver chains must be tested with the antenna arrays.

Making near-field measurements and transforming to obtain the far-field, as in the second technique described above, can provide the far-field radiation profile information in a smaller chamber. However, this approach has some drawbacks. For example, this near-field technique is quite slow. A raster scan of sufficient resolution requires a precision automated process that typically requires several hours. Also, modern DUTs with integrated antenna arrays must be characterized more fully for proper functioning, typically by measuring EVM and ACLRs. While the far-field beam profile may be determined from a transform of near-field measurements, EVM versus beam angle may not be possible with this approach. EVM would have to be measured at many different locations and somehow a mathematical algorithm to predict EVM at a spatial location in the far-field would have to be developed. For many anticipated applications, EVM measurements with less than two percent uncertainty are likely to be required, which would make this approach challenging, especially when one or more components (e.g. power amplifiers) in the transmitter chain are not linear. Also, when the integrated antenna array is to be tested in receive mode, the received signal must appear to be coming from the far-field and the EVM of the receive chain characterized. This is also not possible with a small raster-scanned probe in the near-field. Furthermore, typical receive-mode characterization is performed in the presence of a “blocker,” which is another transmitter at an angle of incidence other than the actual transmitter being tested. Recreating this scenario in a near-field manner is very difficult.

The third technique, while again suitable for radiation profile measurement, is likewise not appropriate for testing of a DUT, including the transmit and receive chains, with an integrated antenna array. Typically, the receiver EVM and ALCRs must be tested in the presence of interfering signals called blockers, provided at different angles of incidence than the desired signal to be demodulated, as mentioned above. The DUT in a CATR is typically located in the quiet zone of the chamber, which provides the most nearly uniform illumination (flat phase front and amplitude across the range). Generally, the quiet zone begins at a length of about 5/3 of the focal length and extends some distance further from a parabolic reflector. In this case, then a second offset blocker near the main source will have its beam not quite collimated. In fact, at sufficiently large displacements from the focal length, the energy may not even pass through the quiet zone.

Characterizing the transmission system is even more difficult using conventional techniques. Because the integrated antenna array cannot be characterized independently of the receive chain, the transmit radiation profile must be independently verified. This is not possible using the conventional third (CATR) technique to characterize the radiation profile of the antenna array using a standard source. The transmit radiation profile and EVM must be actually measured in the far-field with a receiver, which is not a part of a CATR system. Simply positioning the DUT as a replacement for the characterized source in a CATR will not allow a receiver in the quiet zone to characterize the beam profile, or the EVM and ALCR versus beam profile.

### BRIEF DESCRIPTION OF THE DRAWINGS

The illustrative embodiments are best understood from the following detailed description when read with the accompanying drawing figures. It is emphasized that the various features are not necessarily drawn to scale. In fact, the dimensions may be arbitrarily increased or decreased for clarity of discussion. Wherever applicable and practical, like reference numerals refer to like elements throughout the drawings and written description.

FIG. 1 is a simplified block diagram of a system for characterizing a device under test (DUT), including an integrated antenna array, according to a representative embodiment.

FIG. 2 is a simplified cross-sectional view of a system for characterizing a DUT with an integrated antenna array, including a lens as the optical subsystem, according to a representative embodiment.

FIG. 3 is a simplified cross-sectional view of a system for characterizing a DUT with an integrated antenna array, including a mirror as the optical subsystem, according to a representative embodiment.

### DETAILED DESCRIPTION

In the following detailed description, for purposes of explanation and not limitation, example embodiments disclosing specific details are set forth in order to provide a thorough understanding of the present teachings. However, it will be apparent to one of ordinary skill in the art having the benefit of the present disclosure that other embodiments according to the present teachings that depart from the specific details disclosed herein remain within the scope of the appended claims. Moreover, descriptions of well-known apparatuses and methods may be omitted so as to not obscure the description of the example embodiments. Such methods and apparatuses are clearly within the scope of the present teachings.

The terminology used herein is for purposes of describing particular embodiments only, and is not intended to be limiting. The defined terms are in addition to the technical, scientific, or ordinary meanings of the defined terms as commonly understood and accepted in the relevant context.

The terms “a”, “an” and “the” include both singular and plural referents, unless the context clearly dictates otherwise. Thus, for example, “a device” includes one device and plural devices. The terms “substantial” or “substantially” mean to within acceptable limits or degree to one of ordinary skill in the art. The term “approximately” means to within an acceptable limit or amount to one of ordinary skill in the art. Relative terms, such as “above,” “below,” “top,” “bottom,” “upper” and “lower” may be used to describe the various elements” relationships to one another, as illustrated in the accompanying drawings. These relative terms are intended to encompass different orientations of the device and/or elements in addition to the orientation depicted in the drawings. For example, if the device were inverted with respect to the view in the drawings, an element described as “above” another element, for example, would now be below that element. Where a first device is said to be connected or coupled to a second device, this encompasses examples where one or more intermediate devices may be employed to connect the two devices to each other. In contrast, where a first device is said to be directly connected or directly coupled to a second device, this encompasses examples where the two devices are connected together without any intervening devices other than electrical connectors (e.g., wires, bonding materials, etc.).

Generally, according to various embodiments, complete far-field characterization of a device under test (DUT) with an integrated antenna array (e.g. transmit and receive chains included) may be made using an anechoic chamber. Further, multi-channel measurements and fast radiation profile measurements are possible using an array of receivers, detectors, power sensors or other measurement elements.

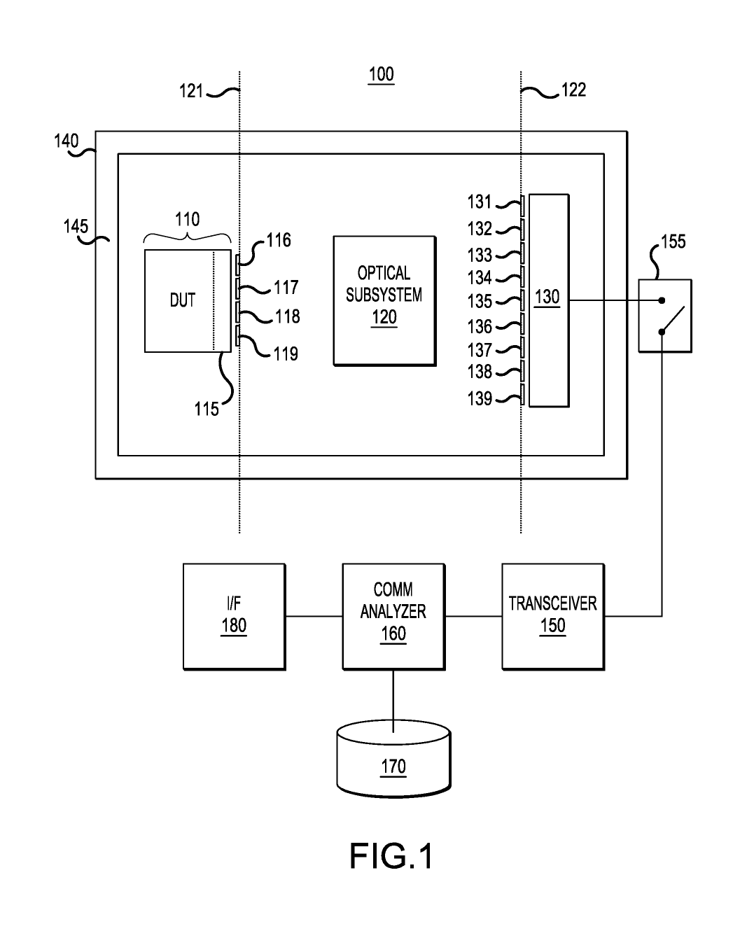

FIG. 1 is a simple block diagram of a system for characterizing a device under test (DUT), including an integrated antenna array, according to a representative embodiment.

Referring to FIG. 1, system 100 is configured to characterize DUT 110, which includes, for example, testing and calibrating antenna array 115, which may be referred to as “DUT antenna array” or “antenna under test (AUT).” The antenna array 115 is integrated with the DUT 110, as indicated by the dotted line, in that the transmit and receive chains of the DUT 110 are directly connected to the elements of the antenna array 115, as opposed to a separate and independently measurable antenna system. In the depicted embodiment, the antenna array 115 includes antennas 116-119, which may be arranged in a matrix-type format, although the antenna array 115 may include various other numbers and arrangements of the antenna, depending on the design of the DUT 110, for example.

Because the antenna array 115 is integrated with the DUT 110, with no RF connections, the antenna array 115 cannot be tested in isolation. That is, it is not possible to simply test the radiation profile of the antenna array 115, and then separately test functionality of the transmitter chain and/or receiver chain of the DUT 110. The characterization of the DUT 110 and the antenna array 115 is therefore performed at the same time, as discussed below.

In the depicted embodiment, the system 100 includes an optical subsystem 120 having a first focal plane 121 and a second focal plane 122, and a measurement array 130 including array elements 131-139. As discussed below, examples of the optical subsystem 120 include a lens, a curved mirror (such as a parabolic mirror, for example), multiple lenses or mirrors, or a hybrid of lens(es) and mirror(s). When the optical subsystem 120 is a lens, the second focal plane 122 may be on an opposite side of the lens than the first focal plane 121. When the optical subsystem 120 is a curved mirror, the second focal plane 122 may be on the same side of the cured mirror as the first focal plane 121, but at different angular locations, e.g., when an off-axis parabolic mirror is utilized. Regardless, the antenna array 115 of the DUT 110 is positioned substantially on the first focal plane 121, while the array elements 131-139 of the measurement array 130 are positioned substantially on the second focal plane 122 of the optical subsystem 120.

With respect to being “substantially” on a focal plane, a general rule for far-field measurements is that the phase errors across the array aperture should vary by less than π/8 radians. With this understanding, it can be shown that even with ideal paraxial optics, accurate far-field measurements can only be obtained with the measurement array (e.g., measurement array 130) and the DUT array (e.g., antenna array 115) when the displacement, d, from the actual focal plane satisfies the following inequality, in which λ is the wavelength of the radiated beam, f is the focal length of the optical subsystem 120, and r is the distance from the center of the array to the array element of farthest extent:

$$d < \frac{λ {f}^{2}}{8 {r}^{2 }}$$

Further, with regard to the measurement array 130, although nine array elements are depicted (array elements 131-139) uniformly spaced in an array pattern, it is understood that different numbers of array elements (e.g., one or more array elements) and arrangements (e.g., a square or matrix-type array pattern) may be incorporated, without departing from the scope of the present teachings.

The measurement array 130 is configured to receive signals transmitted from the antenna array 115 via the optical subsystem 120 in order to measure various parameters of the DUT 110 and/or the antenna array 115. Unlike conventional systems, the system 100 is able to measure the parameters of the integrated DUT 110 and antenna array 115 at each of the array elements 131-139 of the measurement array 130. Each of the array elements 131-139 provides DUT parameter measurements associated with particular radiation angles from the DUT 110. Because of the multiple array elements 131-139, these measurements can be made simultaneously and without requiring rotation or mechanical motion. This significantly speeds up the required measurements, which typically must be measured at many angles across a range of angles. Examples of parameters of the DUT 110 include an error-vector-magnitude (EVM) and adjacent channel leakage ratios (ACLRs), and examples of parameters of the antenna array 114 include radiation profile, effective isotropic radiated power and total radiated power. Because these parameters may be measured or otherwise determined, they may be referred to collectively as “integrated DUT parameters.” In various embodiments, the measurement array 130 is further configured to transmit signals to the antenna array 115 via the optical subsystem 120. This enables determination of the receiver radiation profile, EVM or ACLR of the DUT 110 and/or antenna array 115, for example

The simultaneous measurements are possible because a far-field radiation pattern of the antenna array 115 is created in the second focal plane 122, where the measurement array 130 is positioned, by the configuration of the optical subsystem 120. In other words, the angular distribution of plane waves from the antenna array 115 is transformed to a distribution of off-axis displacement in the second focal plane 122 by the optical subsystem 120. Thus, in the second focal plane 122, a certain displacement corresponds to a certain angle change of the output beam of the antenna array 115 (in the first focal plane 121). In this way, the array elements 131-139 are able to measure the radiation profile of the DUT 110 transmitter, and at the same time, the EVM of a beam from the antenna array 115 aimed at a certain angle and/or the ACLR at the same angle.

Further, a near-field radiation pattern of the antenna array 115 is determinable using a Fourier transform of the far-field radiation pattern created at the measurement array 130. That is, the far-field radiation pattern may be transformed into the near-field radiation pattern, and vice versa, using Fourier-optics concepts. The relationship between the far-field radiation pattern and the near-field radiation pattern is provided by the following equation:

$$U ( x ) ⇒ \frac{1}{λ f} \hat{U} ( \frac{x}{λ f} )$$

Referring again to FIG. 1, the system 100 further includes an anechoic chamber 140, configured to house the DUT 110, the optical subsystem 120, and the measurement array 130. As discussed above, the DUT 110 has integrated antenna array 115, as indicated by the dotted line. Each of the internal walls of the anechoic chamber 140 is covered by an electromagnetic wave absorbing material 145, such as absorbing foam. The electromagnetic wave absorbing material 145 minimizes reflections from the internal walls, e.g., by several tens of decibels, reducing interference. As mentioned above, placement of the antenna array 115 on the first focal plane 121 and placement of the measurement array 130 on the second focal plane 122 results in creation of the far-field radiation pattern in the second focal plane 122. Thus, even at high RF frequencies (e.g., above 5 GHZ), the distances between the antenna array 115 and the measurement array 130 from the optical subsystem 120, respectively, may be relatively small (e.g., less than 100 cm). Accordingly, the anechoic chamber 140 may likewise by relatively small, particularly in comparison to conventional systems. Due to the anechoic chamber 140, the system 100 is considered a compact antenna test range (CATR), which is more manageable and accurate for determining far-field measurements, as opposed to outdoor test ranges, for example. Thus, the system 100 is able to fully characterize (e.g., provide radiation profile, effective isotropic radiated power, total radiated power, EVM and ACLRs) a DUT 110 having an integrated antenna array 115 with a large far-field (e.g., greater than about 1 m) in a compact manner. Also, the system 100 enables fast measurement speed and reciprocal receive and transmit testing using the same configuration, for simultaneous, low cost characterization of the DUT 110 and the antenna array 115.

The array elements 131-139 of the measurement array 130 may include a variety of different types of components, to provide unique benefits for any particular situation or to meet application specific design requirements of various implementations, as would be apparent to one skilled in the art. For example, the array elements 131-139 may include antennas connected to one or more receivers and/or transceivers. In the depicted embodiment, for purposes of illustration, the array elements 131-139 are indicated as antennas, which are selectively connected to representative transceiver 150 through operation of a representative switch 155. The transceiver 150 is therefore able to receive the transmitted signals from the antenna array 115 (and transmit signals to the antenna array 115) via each of the antennas in the measurement array 130.

Although the depicted embodiment shows one transceiver (150) and one switch (switch 155) operable with the multiple array elements 131-139, it is understood that other numbers of transceivers and switches may be incorporated without departing from the scope of the present teachings. For example, each of the array elements 131-139 may have a corresponding, dedicated switch for selectively connecting the array elements 131-139 to the transceiver 150. Or, each of the array elements 131-139 may have a corresponding, dedicated transceiver, in which case the array elements 131-139 may be connected to the corresponding transceiver and there would be no need for the switch(es) 155. Also, as mentioned above, a receiver may be used in place of the transceiver 150, in which case the DUT 110 and integrated antenna array 115 may be characterized, as discussed herein, but there could be no reciprocal transmission to antenna array 115. Alternatively, a transmitter may be used in place of the transceiver 150.

The transceiver 150 and the switch 155 are shown as being outside the anechoic chamber 140, and configured to communicate with the measurement array 130 by a physical connection (as shown), such as a cable, passing through the wall(s) of the anechoic chamber 140, or wirelessly. However, it is understood that one or both of the transceiver 150 and the switch 155 may be located inside the anechoic chamber 140, without departing from the scope of the present teachings. Various components may communicate wirelessly within the anechoic chamber 140, as well.

In the depicted embodiment, the system 100 further includes a communication analyzer 160 configured to perform the substantially simultaneous measurements of the integrated DUT parameters, memory 170 configured to store at least a portion of the measurement results; and interface (I/F) 180 to enable interfacing with a user and/or another test device. For example, the I/F 180 may include display 186 configured to display at least a portion of the measurement results, as well a user input device 188 configured to receive user commands. The user input device 188 may include a keyboard, a mouse, a touch pad and/or a touch-sensitive display, although any other compatible means of providing input may be incorporated without departing from the scope of the present teachings.

The communication analyzer 160 may be implemented by a computer processor, application specific integrated circuits (ASICs), field-programmable gate arrays (FPGAs), or combinations thereof, using software, firmware, hard-wired logic circuits, or combinations thereof. Examples of the communication analyzer 160 may include a signal generator, a signal analyzer, a communication transceiver, or various combinations thereof. A computer processor, in particular, may be constructed of any combination of hardware, firmware or software architectures, and may include its own memory (e.g., nonvolatile memory) for storing executable software/firmware executable code that allows it to perform the various functions. In an embodiment, the computer processor may comprise a central processing unit (CPU), for example, executing an operating system. The memory 170 may be implemented by any number, type and combination of random access memory (RAM) and read-only memory (ROM), for example, and may store various types of information, such as computer programs and software algorithms executable by the communication analyzer 160 (and/or other components), as well as raw data and/or measurement data storage, for example. The various types of ROM and RAM may include any number, type and combination of computer readable storage media, such as a disk drive, an electrically programmable read-only memory (EPROM), an electrically erasable and programmable read only memory (EEPROM), a CD, a DVD, a universal serial bus (USB) drive, and the like, which are tangible and non-transitory storage media (e.g., as compared to transitory propagating signals).

Alternatively, the array elements 131-139 may include detectors, such as power sensing diodes. The power sensing diodes may be configured to perform the substantially simultaneous measurements of the integrated DUT parameters, for example, measurements of the radiation profile, which is basically power measured as a function of angle. In various embodiments, the measurements may be sent to the communication analyzer 160 and/or the memory 170.

As mentioned above, the depicted embodiment allows for measurement of the DUT 110 in a reciprocal manner, when the array elements 131-139 of the measurement array 130 are antennas selectively connected to the transceiver 150. In this case, the array elements 131-139 are further configured to transmit signals to the antenna array 115, via the optical subsystem 120. Each of the array elements 131-139 generates a substantially collimated beam of a particular angle at the antenna array 115 and creates a far-field pattern input to the DUT 110. In this way, the receiver beam pattern of the DUT 110 may be measured by rotating the DUT 110, for example, in the presence of the collimated beam from the optical subsystem 120. At the same time, the EVM of the receiver channel may be measured when the source (transceiver 150) is modulated. The ACLR of the receive channel may also be measured. As mentioned above, the receive test for the DUT 110 typically involves an interfering blocker that presents a far-field illumination from a different angle. This can be accomplished by simultaneously illuminating the DUT 110 with modulated signals from two different array elements 131-139 in the second focal plane 122.

Path loss and other losses may reduce signal-to-noise ratio (SNR) of a particular measurement. However, in the depicted embodiment, the Poynting vector for the wave at the second focal plane 122, opposite the DUT 110 and integrated antenna array 115, is approximately perpendicular to the measurement array 130. This allows for high-gain and directional antennas to be used as the array elements 131-139, as mentioned above, such that signal levels may be increased. Also, in a conventional CATR, a quiet zone is important because stray reflections off surfaces are added (via superposition) to the desired fields to be measured, thus inducing errors. The quiet zone has minimal unwanted reflections. However, with high-gain and directional antennas used as the array elements 131-139 in the second focal plane 122, the effects of stray reflections are minimized since they must be incident on the array elements 131-139 at just a few degrees around normal to the focal plane to have an impact on the measurement.

Measuring performance of the DUT 110 and integrated antenna array 115 in reflection mode may be reciprocal. With a high gain transmit antenna from the test source, the beam is quite narrow and so few stray reflections are induced. The proper beam angle and far-field radiation pattern from the source is created with minimal impairments in this way.

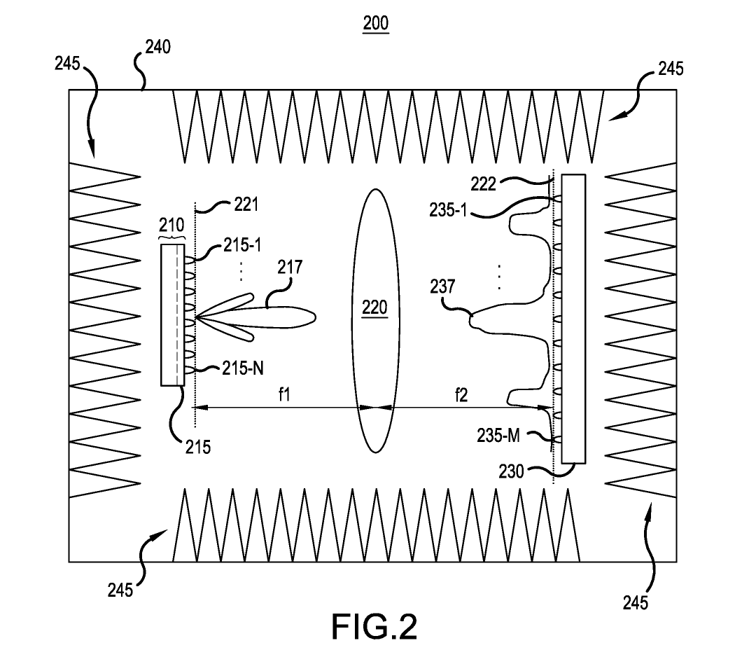

FIG. 2 is a simplified cross-sectional view of a system for characterizing a DUT with an integrated antenna array, including a lens as the optical subsystem, according to a representative embodiment.

Referring to FIG. 2, system 200 is configured to characterize a DUT 210 with an integrated antenna array 215, indicated by the dashed line. In the depicted example, the antenna array 215 includes antennas 215-1 to 215n (where n is a positive integer), e.g., arranged in a matrix-type format, although the antenna array 215 may include various numbers and arrangements of the antennas, depending on the design of the DUT 210, for example. The DUT 210 and the integrated antenna array 215 are generally similar to the illustrative DUT 110 and integrated antenna array 115 described above with reference to FIG. 1.

In the depicted embodiment, the system 200 includes a lens 220 as the optical subsystem, where the lens 220 has a first focal plane 221 and a second focal plane 222. The lens 220 is a double convex lens, although different types of lenses configured to provide corresponding first and second focal planes, such as a plano-convex lens or a double convex lens, for example, may be incorporated without departing from the scope of the present teachings. The antenna array 215 (and/or the DUT 210) is located substantially on the first focal plane 221.

The system 200 also includes a measurement array 230, having one or more array elements 235-1 to 235-m (where m is a positive integer), e.g., arranged in a matrix-type format, although the measurement array 230 may include various numbers and arrangements of the elements to provide unique benefits for any particular situation or to meet application specific design requirements of various implementations, as would be apparent to one skilled in the art. For example, as mentioned above, the measurement array 230 may include a single array element (e.g., 235-1). The measurement array 230 and the array elements 235-1 to 235-n are generally similar to the illustrative measurement array 130 and array elements 131-139 described above. For example, in various configurations, the measurement array 230 may be connected to one or more transceivers (150) and one or more switches (155), as well as a communication analyzer (160), memory (170) and an interface (180). The measurement array 230 is located substantially on the second focal plane 222, thus the antenna array 215 and the measurement array 230 are on opposite sides of the lens 220. The DUT 210 and integrated antenna array 215, the lens 220, and the measurement array 230 are located within an anechoic chamber 240, which includes absorbing material 245 on the interior walls.

As discussed above, the far-field radiation pattern of the antenna array 215 is created in the second focal plane 222, where the measurement array 230 is positioned, by the configuration of the lens 220. Accordingly, the system 200 is able to measure the parameters of the integrated DUT 210 and antenna array 215 simultaneously at each of the array elements 235-1 to 235-n of the measurement array 230, including the EVM and the ACLRs of the DUT 210 and the radiation profile, the effective isotropic radiated power and the total radiated power of the antenna array 215.

For purposes of illustration, each of the focal length f1 from the lens 220 to the first focal plane 221 and the focal length f2 from the lens 220 to the second focal plane 222 is 20 cm. Also, for purposes of illustration, the DUT 210 may be a wireless communications device operating at 28 GHz, and the antenna array 215 may be an 8×8 antenna array in which the antennas are separated by λ/2 (where λ is the wavelength of the RF signal transmitted from the antenna array 215). More generally, the antenna array 215 comprises an M×N array of antennae, where M and N are positive integers, respectively, separated from one another by λ/2. The antenna array 215 is located substantially on the first focal plane 221. That is, the antenna array 215 may be placed at different (relatively short) distances from the first focal plane 221, as discussed with reference to the inequality above regarding displacement (d), with similar measurement results (e.g., just phase differences) at the measurement array 230. Generally, closer placement of the antenna array 215 to the lens 220 may ease f/# requirements, for example, and improve the angular span of measurement.

In the example of FIG. 2, the antenna array 215 is approximately 4 cm across, and emits an RF signal having representative radiation pattern 217. The RF signal is received at the measurement array 230 located substantially on the second focal plane 222 for measurement, indicated by radiation profile 237, which provides amplitude and phase directly. For purposes of illustration, the measurement array 230 may include about 11 array elements (e.g., like array elements 131-139, discussed above) with an array pitch of about 1.75 cm spacing, thus providing about 5 degree angular resolution for radiation profile measurements, although other specifications may be incorporated, e.g., depending on design requirements and/or DUT and integrated antenna characteristics, without departing from the scope of the present teachings. In the depicted example, the necessary working volume is only about 30 cm×30 cm×50 cm. Also, as discussed above, receiver testing of the DUT 210 may be accomplished in a reciprocal fashion. Transmitters in a transform plane would appear as far-field with angle of incidence determined by position off axis. Blocking could be implemented in substantially the same manner

In the depicted embodiment, reflections from the lens 220 may cause issues with multiple beam bounces. The effects of the reflections may be mitigated by positioning an attenuator (not shown) between the DUT 210 and the lens 220. Also, when the measurement array 230 is a one-dimensional array, for example, the lens 220 may be cylindrical and tilted to ensure multi-bounce reflections are not sensed on the measurement array 230.

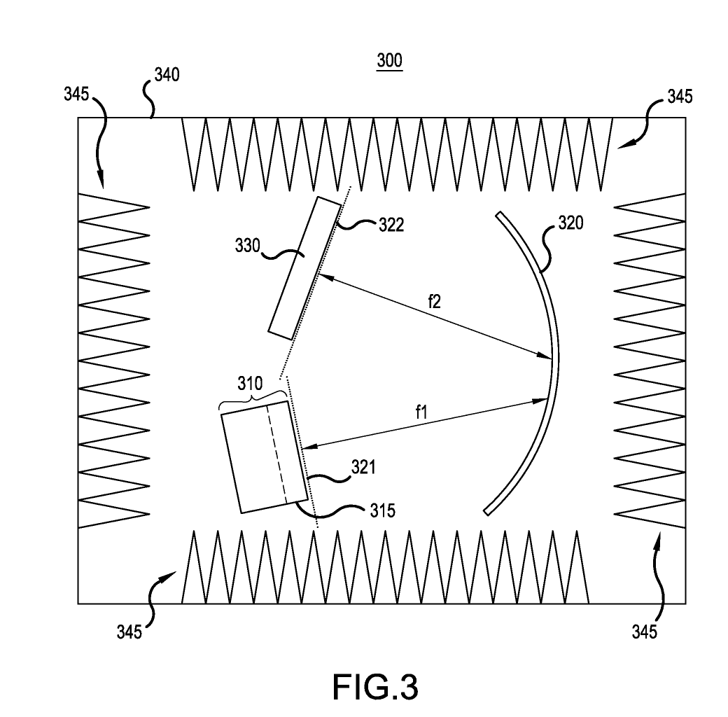

FIG. 3 is a simplified cross-sectional view of a system for characterizing a DUT with an integrated antenna array, including a mirror as the optical subsystem, according to a representative embodiment.

Referring to FIG. 3, system 300 is configured to characterize a DUT 310 with an integrated antenna array 315, indicated by the dashed line. In the depicted example, the antenna array 315 includes antennas 315-1 to 315n (where n is a positive integer), e.g., arranged in a matrix-type format, although the antenna array 315 may include various numbers and arrangements of the antennas, depending on the design of the DUT 310, for example. The DUT 310 and the integrated antenna array 315 are generally similar to the illustrative DUT 110 and integrated antenna array 115 described above with reference to FIG. 1.

In the depicted embodiment, the system 300 includes a curved mirror 320 as the optical subsystem, where the curved mirror 320 has a first focal plane 321 and a second focal plane 322. The curved mirror 320 may be a parabolic mirror, for example, although different types of curved mirrors configured to provide corresponding first and second focal planes may be incorporated without departing from the scope of the present teachings. In the present example, the curved mirror 320 has a mirror radius of about 60 cm, and an area of about 40 cm×40 cm, although other dimensions may be incorporated, e.g., depending on design requirements and/or DUT and integrated antenna characteristics, without departing from the scope of the present teachings. The antenna array 315 (and/or the DUT 310) is located substantially on the first focal plane 321.

The system 300 also includes a measurement array 330, having one or more array elements (not shown in FIG. 3), e.g., arranged in a matrix-type format, although the measurement array 330 may include various numbers and arrangements of the array elements to provide unique benefits for any particular situation or to meet application specific design requirements of various implementations, as would be apparent to one skilled in the art. For example, as mentioned above, the measurement array 330 may include a single array element. The measurement array 330 and the array elements are generally similar to the illustrative measurement array 130 and array elements 131-139 described above. For example, in various configurations, the measurement array 330 may be connected to one or more transceivers (150) and one or more switches (155), as well as a communication analyzer (160), memory (170) and an interface (180). The measurement array 330 is located substantially on the second focal plane 322, thus the antenna array 315 and the measurement array 330 are on the same side of the curved mirror 320, although position at different angles. The DUT 310 and integrated antenna array 315, the curved mirror 320, and the measurement array 330 are located with an anechoic chamber 340, which includes absorbing material 345 on the interior walls.

As discussed above, the far-field radiation pattern of the antenna array 315 is created in the second focal plane 322, where the measurement array 330 is positioned, by the configuration of the curved mirror 320. Accordingly, the system 300 is able to measure the parameters of the integrated DUT 310 and antenna array 315 simultaneously at each of the array elements 335-1 to 335-n of the measurement array 330, including the EVM and the ACLRs of the DUT 310 and the radiation profile, the effective isotropic radiated power and the total radiated power of the antenna array 315.

For purposes of illustration, each of the focal length f1 from the curved mirror 320 to the first focal plane 321 and the focal length f2 from the curved mirror 320 to the second focal plane 322 is about 30 cm. The antenna array 315 is located substantially on the first focal plane 321. In the example of FIG. 3, the antenna array 315 is approximately 20 cm across, and emits an RF signal having a representative radiation pattern which may be substantially the same as that of antenna array 215 in FIG. 2. The RF signal is received at the measurement array 330 located substantially on the second focal plane 322 for measurement, which provides a corresponding radiation profile, which may be substantially the same as the radiation profile 237 in FIG. 2. For purposes of illustration, the measurement array 330 may be about 30 cm×30 cm in area, with about a 1 cm displacement on array approximately equal to 1 degree beam angle variation for radiation profile measurements. As discussed above, receiver testing of the DUT 310 may be accomplished in a reciprocal fashion.

Accordingly, a system is provided for characterizing a DUT having integrated antenna array. The system includes an optical subsystem having first and second focal planes, where the integrated antenna array is positioned substantially on the first focal plane of the optical subsystem. The optical subsystem may be a lens or a curved mirror, for example. The system further includes a measurement array having one or more array elements positioned substantially on the second focal plane of the optical subsystem. The measurement array is configured to receive signals transmitted from the integrated antenna array via the optical subsystem. A far-field radiation pattern of the integrated antenna array is created at the measurement array, enabling substantially simultaneous measurements of DUT parameters at each array element of the one or more array elements in the measurement array. Various embodiments enable measurement of the DUT in a reciprocal manner, when the measurement array includes antennas that are (selectively) connected to one or more transceivers.

The various components, structures, parameters and methods are included by way of illustration and example only and not in any limiting sense. In view of this disclosure, those skilled in the art can implement the present teachings in determining their own applications and needed components, materials, structures and equipment to implement these applications, while remaining within the scope of the appended claims.

What is claimed:

1. A system for characterizing a device under test (DUT) comprising an integrated antenna array, the system comprising:
an optical subsystem having first and second focal planes, wherein the integrated antenna array is positioned substantially on the first focal plane of the optical subsystem; and
a measurement array comprising one or more array elements positioned substantially on the second focal plane of the optical subsystem, the measurement array being configured to receive signals transmitted from the integrated antenna array via the optical subsystem,
wherein a far-field radiation pattern of the integrated antenna array is created at the measurement array, enabling measurements of DUT parameters at each array element of the one or more array elements in the measurement array.

2. The system of claim 1, wherein the measurements of the DUT parameters are made substantially simultaneously by the measurement array, and wherein the DUT parameters comprise at least one of a radiation profile, an effective isotropic radiated power and total radiated power of the integrated antenna array, and an error-vector-magnitude (EVM) and an adjacent channel leakage ratio (ACLR) of the DUT.

3. The system of claim 1, further comprising:
an anechoic chamber housing the DUT, the optical subsystem, and the measurement array.

4. The system of claim 1, wherein the one or more array elements in the measurement array comprises a plurality of detectors.

5. The system of claim 4, wherein the plurality of detectors comprises a plurality of power sensing diodes configured to perform the substantially simultaneous measurements of the DUT parameters.

6. The system of claim 1, wherein the one or more array elements comprises a plurality of antennas.

7. The system of claim 6, further comprising:
a switch;
at least one receiver selectively connectable to each of the plurality of antennas via the switch to receive the transmitted signals from the integrated antenna array; and
a communication analyzer configured to perform the measurements of the DUT parameters.

8. The system of claim 7, further comprising:
a memory configured to store at least a portion of the measurements; and
a display configured to display at least a portion of the measurements.

9. The system of claim 1, wherein the optical subsystem comprises a curved mirror.

10. The system of claim 1, wherein the optical subsystem comprises a lens.

11. The system of claim 1, wherein the one or more array elements of the measurement array comprise a plurality of antennas configured to transmit signals to the integrated antenna array, via the optical subsystem, each array element generating a substantially collimated beam of a particular angle at the integrated antenna array.

12. The system of claim 11, wherein receipt by the integrated antenna array of the signals transmitted by the plurality of antennas enables measurement of the radiation pattern of the integrated antenna array.

13. The system of claim 11, further comprising:
a switch; and
at least one transceiver selectively connectable to each of the plurality of antennas in the measurement array via the switch to receive the transmitted signals from the integrated antenna array and to transmit signals to the integrated antenna array.

14. The system of claim 11, wherein receipt by the integrated antenna array of the signals transmitted by the plurality of antennas enables measurement of EVM and ACLR of receive channels receiving the signals, when the signals transmitted by the plurality of antennas are modulated, respectively.

15. A system for characterizing a device under test (DUT) comprising an integrated antenna array, the system comprising:
a curved mirror having a first focal plane, wherein the integrated antenna array is positioned substantially on the first focal plane of the curved mirror; and
a measurement array comprising a plurality of detectors substantially positioned on a second focal plane of the curved mirror, the plurality of detectors being configured to receive signals transmitted from the integrated antenna array and reflected by the curved mirror,
wherein a far-field radiation pattern of the integrated antenna array is created at the measurement array, enabling measurements of DUT parameters at each detector of the plurality of detectors from the signals transmitted from the integrated antenna array.

16. The system of claim 15, further comprising:
an anechoic chamber housing the DUT, the curved mirror and the measurement array.

17. The system of claim 15, wherein the curved mirror comprises a parabolic mirror.

18. A system for characterizing a device under test (DUT) comprising an integrated antenna array, the system comprising:
a lens having a first focal plane on one side of the lens and a second focal plane on an opposite side of the lens, wherein the integrated antenna array is positioned substantially on the first focal plane of the lens; and
a measurement array comprising a plurality of detectors substantially positioned on the second focal plane of the lens, the plurality of detectors being configured to receive signals transmitted from the integrated antenna array through the lens,
wherein a far-field radiation pattern of the integrated antenna array is created at the measurement array, enabling measurements of DUT parameters at each detector of the plurality of detectors from the signals transmitted from the integrated antenna array.

19. The system of claim 18, further comprising:
an attenuator positioned between the DUT and the one side of the lens, the attenuator being configured to mitigate reflections by the lens of the signals transmitted from the integrated antenna array.

20. The system of claim 19, wherein the integrated antenna array comprises an M×N array of antennae, where M and N are positive integers, respectively, separated from one another by λ/2, wherein λ is a wavelength of a signal transmitted from the integrated antenna array.
